(19) United States
(12) Patent Application Publication
(10) Pub. No.: US 2025/0192659 A1
(43) Pub. Date: Jun. 12, 2025

(54) SPIKE SUPPRESSION DEVICE FOR SUPPRESSING CURRENT-SPIKE IN SWITCHED CAPACITOR CIRCUIT

(71) Applicant: INDUSTRIAL TECHNOLOGY RESEARCH INSTITUTE, Hsinchu (TW)

(72) Inventors: Wen-Tien TSAI, Liuqiu Township (TW); Ching-Ran LEE, Jinning Township (TW); Che-Min KUNG, Zhubei City (TW); Chi-Chun HUANG, Toufen City (TW)

(73) Assignee: INDUSTRIAL TECHNOLOGY RESEARCH INSTITUTE, Hsinchu (TW)

(21) Appl. No.: 18/778,408

(22) Filed: Jul. 19, 2024

(30) Foreign Application Priority Data
Dec. 7, 2023 (TW) 112147648

(51) Int. Cl. H02M 1/00; H02M 1/32

(52) U.S. Cl. CPC H02M 1/0038; H02M 1/32

(57) ABSTRACT

A spike suppression device, for suppressing a spike current in a switched capacitor circuit, and the switched capacitor circuit includes an output capacitor and at least one input capacitor. The spike suppression device includes an inductive reactance element and a switch unit. The inductive reactance element is disposed between the output capacitor and the at least one input capacitor. The switch unit is coupled to the inductive reactance element. The inductive reactance element generates an induced voltage in response to the spike current. The induced voltage is opposite to the spike current, and the switch unit forms a discharge path of the inductive reactance element.

This application claims the benefit of Taiwan application Serial No. 112147648, filed Dec. 7, 2023, the present disclosure of which is incorporated by reference herein in its entirety.

### TECHNICAL FIELD

The present disclosure relates to an electronic device, and in particular relates to a spike suppression device for suppressing “current-spike” in a switched capacitor circuit.

### BACKGROUND

In the technology of semiconductor and electronics, the switched capacitor circuit may be applied for charging, buck supplying or sampling for analog-to-digital conversion. Alternatively, the switched capacitor circuit may be applied for simulating resistive elements. The switched capacitor circuit is composed of several capacitors and switches. When the switches are switched rapidly, a spike current may be generated due to imbalance of voltage or current (which may be referred to as a “current-spike” phenomenon).

The “current-spike” phenomenon may affect the operation of the switched capacitor circuit and reduce the life of elements of the switched capacitor circuit. Therefore, it is necessary to deal with the “current-spike” phenomenon. However, conventional processing mechanisms for the “current-spike” phenomenon usually need to dispose additional control circuits or high-cost circuitry elements and implement complex control mechanisms.

In view of the above issues, it is necessary to provide an improved processing circuit for dealing with the “current-spike” phenomenon, so as to achieve an effect of suppressing the spike current using a simplified control mechanism.

### SUMMARY

According to one embodiment of the present disclosure, a spike suppression device is provided. The spike suppression device is for suppressing a spike current in a switched capacitor circuit, and the switched capacitor circuit comprises an output capacitor and at least one input capacitor. The spike suppression device comprises an inductive reactance element and a switch unit. The inductive reactance element is disposed between the output capacitor and the at least one input capacitor. The switch unit is coupled to the inductive reactance element. The inductive reactance element is configured to generate an induced voltage in response to the spike current, the induced voltage is opposite to the spike current, and the switch unit is configured to form a discharge path of the inductive reactance element.

### BRIEF DESCRIPTION OF THE DRAWINGS

FIG. 1 illustrates a circuit diagram of a switched capacitor circuit 1000 according to an embodiment of the present disclosure.

FIGS. 2A and 2B illustrate schematic diagrams of the switched capacitor circuit operating in the charge mode.

FIG. 2C illustrates a schematic diagram of the spike current in the charge mode.

FIGS. 3A and 3B illustrate schematic diagrams of the switched capacitor circuit operating in the discharge mode.

FIG. 3C illustrates a schematic diagram of the spike current in the discharge mode.

FIGS. 4A and 4B illustrate schematic diagrams of the switched capacitor circuit operating in the dead zone.

FIG. 4C illustrates a schematic diagram of the operation of the spike suppression device in the dead zone.

FIG. 5A illustrates a circuit diagram of a spike suppression device 100 according to an embodiment of the present disclosure.

FIG. 5B illustrates waveform diagrams of the control signals in the charge mode, the discharge mode and the dead zone.

FIG. 5C illustrates a circuit diagram of a spike suppression device according to another embodiment of the present disclosure.

FIG. 6A illustrates a circuit diagram of a switched capacitor circuit according to another embodiment of the present disclosure.

FIG. 6B illustrates a circuit diagram of the spike suppression device in FIG. 6A and illustrates its operation and the connection relationship between the elements of the spike suppression device and the switched capacitor circuit.

FIGS. 6C and 6D illustrate schematic diagrams of the switched capacitor circuit of FIG. 6B operating in the charge mode.

FIGS. 6E and 6F illustrate schematic diagrams of the switched capacitor circuit of FIG. 6B operating in the discharge mode.

FIG. 7 illustrates a waveform diagram of the input current of the switched capacitor circuit in FIG. 6B.

FIG. 8 illustrates a waveform diagram of the input current of the switched capacitor circuit in a comparative example.

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

### DETAILED DESCRIPTION

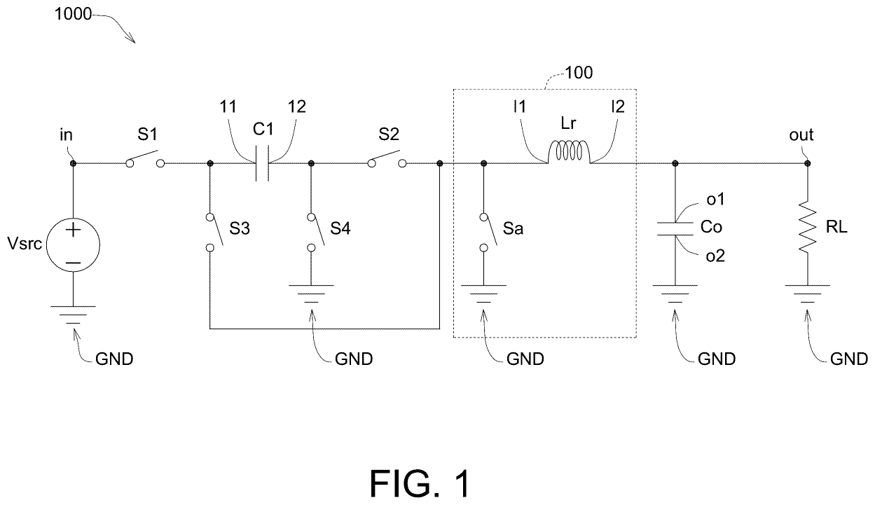

Please refer to FIG. 1, which illustrates a circuit diagram of a switched capacitor circuit 1000 according to an embodiment of the present disclosure. The switched capacitor circuit 1000 may be applied for charging, buck supplying, sampling for analog-to-digital conversion or simulating resistive elements. In the example of FIG. 1, the switched capacitor circuit 1000 includes an input capacitor C1, an output capacitor Co and four switches S1 to S4. Furthermore, an input end “in” of the switched capacitor circuit 1000 is coupled to the voltage source Vsrc, and the output end “out” of the switched capacitor circuit 1000 is coupled to the load resistor RL.

More specifically, the voltage source Vsrc is coupled between the ground end GND and the input end “in” of the switched capacitor circuit 1000. The switch S1 is coupled between the input end “in” of the switched capacitor circuit 1000 and one end 11 of the input capacitor C1. The switch S4 is coupled between another end 12 of the input capacitor C1 and the ground end GND. The switch S2 and switch S3 are coupled to the input capacitor C1, and the switch S2 and switch S3 are coupled to each other.

The load resistor RL is coupled between the output end “out” of the switched capacitor circuit 1000 and the ground end GND. One end o1 of the output capacitor Co is coupled to the output end “out” of the switched capacitor circuit 1000 and the load resistor RL. Another end o2 of the output capacitor Co is coupled to the ground end GND.

The spike suppression device 100 according to an embodiment of the present disclosure is applied to the switched capacitor circuit 1000. The spike suppression device 100 is directly coupled to the output capacitor Co and coupled to the input capacitor C1 through the switch S2. The spike suppression device 100 includes an inductive reactance element Lr and a switch unit Sa. One end I1 of the inductive reactance element Lr is coupled to the switch S2 and the switch unit Sa. Furthermore, another end I2 of the inductive reactance element Lr is coupled to one end o1 of the output capacitor Co, the load resistor RL and the output end “out” of the switched capacitor circuit 1000. The switch unit Sa is coupled between one end I1 of the inductive reactance element Lr and the ground end GND. In the embodiment of FIG. 1, the switch S2 is disposed between the input capacitor C1 and the inductive reactance element Lr, therefore, the switch S2 may be referred to as “the first switch element” of the switched capacitor circuit 1000 of this embodiment.

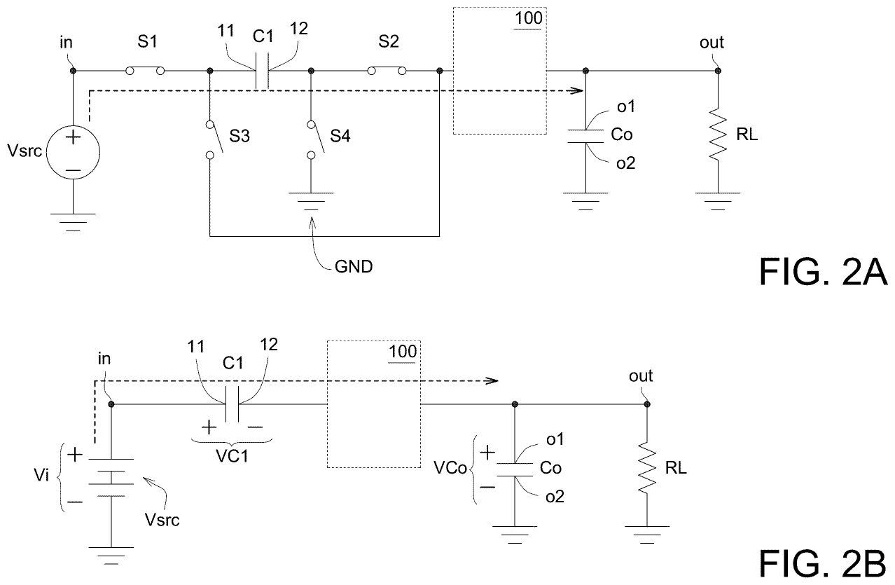

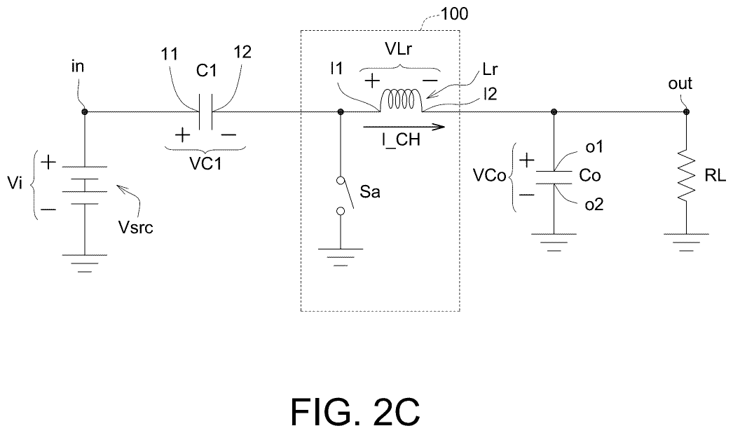

The switched capacitor circuit 1000 may operate in a charge mode and a discharge mode. First, please refer to FIGS. 2A and 2B, which illustrate schematic diagrams of the switched capacitor circuit 1000 operating in the charge mode. In the charge mode, the switches S1 and S2 are both turned ON, and the switches S3 and S4 are both turned OFF. One end 12 of the input capacitor C1 is coupled to one end o1 of the output capacitor Co through the switch S2 which is turned ON and the spike suppression device 100. Accordingly, the coupling manner of the input capacitor C1 and the output capacitor Co is substantially equivalent to series-coupling. The voltage source Vsrc charges the input capacitor C1 and the output capacitor Co (which are coupled in series equivalently) through the switch S1 which is turned ON. The charge current flows from the voltage source Vsrc to the output capacitor Co and the load resistor RL through the input capacitor C1 and the spike suppression device 100.

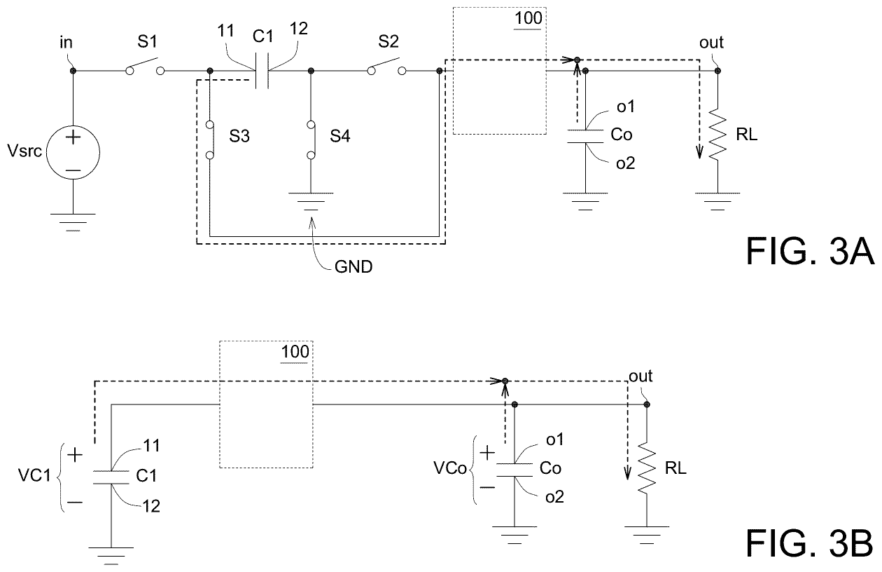

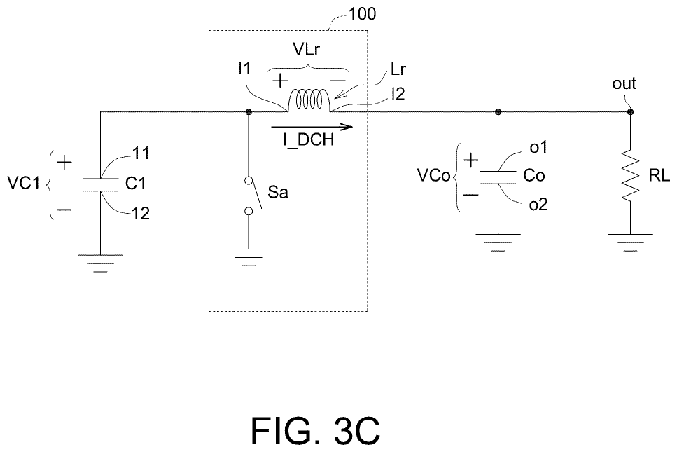

Next, please refer to FIGS. 3A and 3B, which illustrate schematic diagrams of the switched capacitor circuit 1000 operating in the discharge mode. In the discharge mode, the switches S1 and S2 are both turned OFF, and the switches S3 and S4 are both turned ON. One end 12 of the input capacitor C1 is coupled to the ground end GND through the switch S4 which is turned ON, and the other end 11 of the input capacitor C1 is coupled to one end o1 of the output capacitor Co through the switch S3 (which is turned ON) and the spike suppression device 100. Accordingly, the coupling manner of the input capacitor C1 and the output capacitor Co is substantially equivalent to parallel-coupling. The input capacitor C1 and the output capacitor Co, which are equivalently coupled in parallel, perform discharging. The discharge current of the input capacitor C1 flows through the spike suppression device 100 and is collected into the discharge current of the output capacitor Co and then flows into the load resistor RL. The electrical energy released by the input capacitor C1 and the output capacitor Co is transferred to the load resistor RL.

In the discharge mode, the input capacitor C1 and the output capacitor Co are connected in parallel. The voltage VC1 between the two ends 11 and 12 of the input capacitor C1 is equal to the voltage VCo between the two ends o1 and o2 of the output capacitor Co. Therefore, after the discharge mode ends and transforms an initial stage of the charge mode, when the voltage source Vsrc provides the input voltage Vi, the voltage VC1 of the input capacitor C1 is substantially equal to Vi/2, and the voltage VCo of the output capacitor Co is also substantially equal to Vi/2 (i.e., the values of voltage VC1 and voltage VCo are equal). During a charging period after the initial stage of the charge mode, the output capacitor Co continues to supply power to the load resistor RL, hence, the voltage VCo of the output capacitor Co decreases. In contrast, the voltage VC1 of the input capacitor C1 increases by an equal amount as the voltage VCo of the output capacitor Co decreases. (i.e., the decrease amount ΔV of the voltage VCo is equal to the increase amount ΔV of the voltage VC1). Therefore, when the charge mode ends, the voltage VCo of the output capacitor Co decreases to Vi/2−ΔV, and the voltage VC1 of the input capacitor C1 increases to Vi/2+ΔV.

Based on the above, after the charge mode ends and transforms the initial stage of the discharge mode, the voltage VCo of the output capacitor Co is Vi/2−ΔV, and the voltage VC1 of the input capacitor C1 is Vi/2+ΔV. Hence, there is a voltage difference 2ΔV between the voltage VCo and the voltage VC1. Therefore, when in the discharge mode the input capacitor C1 and the output capacitor Co are connected in parallel, the voltage difference 2ΔV will cause a spike current. Please refer to FIG. 3C, which illustrates a schematic diagram of the spike current I_DCH in the discharge mode. The spike current I_DCH caused by the voltage difference 2ΔV between voltage VCo and voltage VC1 flows from one end 11 of the input capacitor C1 to one end o1 of the output capacitor Co.

Next, during the discharging period after the initial stage of the discharge mode, the input capacitor C1 and the output capacitor Co are still connected in parallel. The input capacitor C1 and the output capacitor Co jointly supply power to the load resistor RL. The voltage VC1 of the input capacitor C1 is substantially equal to the voltage VCo of the input capacitor Co, and both the voltages VC1 and VCo continue to decrease. When the discharge mode ends, both the voltages VC1 and VCo are equal to Vi/2−ΔV, and a sum of the voltages VC1 and VCo is Vi-2ΔV, which is less than the input voltage Vi of the voltage source Vsrc. Next, please refer to FIG. 2C, which illustrates a schematic diagram of the spike current I_CH in the charge mode. After the discharge mode ends and transforms to the initial stage of the charge mode (at this time, the input capacitor C1 and the output capacitor Co are changed as series-connecting), and there is a voltage difference 2ΔV between the input voltage Vi of the voltage source Vsrc and a summed voltage (i.e., the sum (Vi-2ΔV) of the voltages VC1 and VCo) of the input capacitor C1 and the output capacitor Co, which causes the spike current I_CH to be generated when the voltage source Vsrc, the input capacitor C1 and the output capacitor Co are connected in series. The spike current I_CH flows from the voltage source Vsrc to the input capacitor C1 and the output capacitor Co. Since the spike current I_CH may generate electromagnetic interference (EMI), it may also damage the elements of the switched capacitor circuit 1000 and reduce life of elements and circuitry stability.

Please refer to FIG. 2C again, according to Faraday's law of electromagnetic induction, when the spike current I_CH flows through the inductive reactance element Lr of the spike suppression device 100, the induced voltage VLr generated by the inductive reactance element Lr is proportional to the changing rate of the spike current I_CH, and the induced voltage VLr is opposite to the spike current I_CH. For example, the spike current I_CH flows from one end I1 of the inductive reactance element Lr to the other end I2 thereof, and the induced voltage VLr is: one end I1 of the inductive reactance element Lr is a positive voltage, and the other end I2 is a negative voltage. Therefore, the induced voltage VLr may suppress the spike current I_CH, in other words, the inductive reactance element Lr will generate “self-impedance” to resist the spike current I_CH.

Please refer to FIG. 3C again, in the discharge mode, the switch unit Sa of the spike suppression device 100 is turned OFF, and the discharge current flows through the inductive reactance element Lr of the spike suppressing device 100, hence, the inductive reactance element Lr absorbs electrical energy. Moreover, when the spike current I_DCH occurs, the inductive reactance element Lr generates the induced voltage VLr in response to the spike current I_DCH. The induced voltage VLr is: one end I1 of the inductive reactance element Lr is a positive voltage and the other end I2 thereof is a negative voltage. Therefore, the induced voltage VLr may suppress the spike current I_DCH.

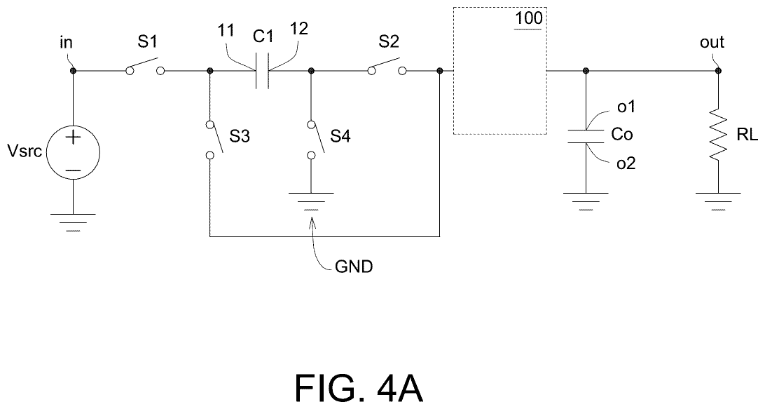

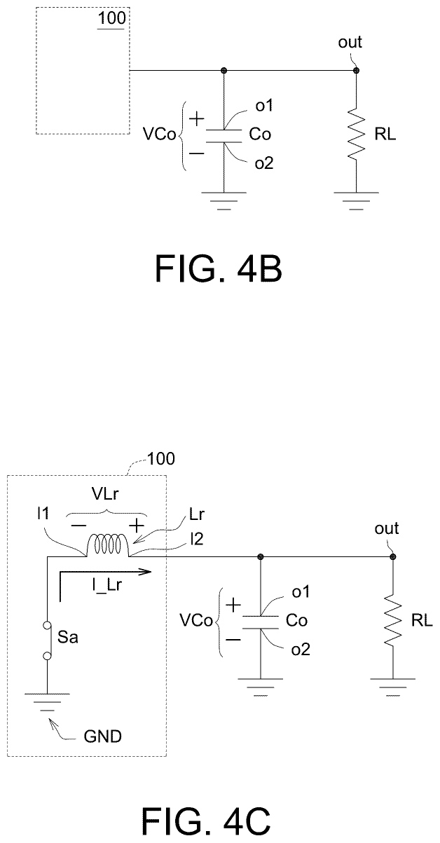

On the other hand, a “dead-zone” is an intermediate process between the charge mode and the discharge mode of the switched capacitor circuit 1000. Please also refer to FIGS. 4A and 4B, which illustrate schematic diagrams of the switched capacitor circuit 1000 operating in the dead zone. In the dead zone, the switches S1, S2, S3 and S4 are all turned OFF, the output capacitor Co is not coupled to the input capacitor C1, and the output capacitor Co is coupled to the spike suppression device 100.

Next, please refer to FIG. 4C, which illustrates a schematic diagram of the operation of the spike suppression device 100 in the dead zone. In the dead zone, the induced voltage VLr is inverted as: one end I2 of the inductive reactance element Lr is a positive voltage, and the other end I1 thereof is a negative voltage. Furthermore, the switch unit Sa of the spike suppression device 100 is turned ON. The switch unit Sa, which is turned ON, forms a discharge path of the inductive reactance element Lr. The current I_Lr of the inductive reactance element Lr may release the electrical energy absorbed by the inductive reactance element Lr to the output capacitor Co through a loop formed by the output capacitor Co and the switch unit Sa which is turned ON.

In the embodiments of FIGS. 1, 2A-2C, 3A-3C and 4A-4C, the inductive reactance element Lr of the spike suppression device 100 may be various types of inductive reactance elements, such as: an independently disposed inductor, or a parasitic-wire-inductor between the output capacitor Co and the input capacitor C1 (e.g., the parasitic-wire-inductor generated by a connecting wire between the output capacitor Co and the input capacitor C1). In other words, the inductive reactance element Lr may be a section of connecting wire between the output capacitor Co and the input capacitor C1, which may have various conductive materials (e.g., copper wire, or gold wire). Alternatively, the inductive reactance element Lr may also be a section of trace on the printed circuit board (PCB) at which the switched capacitor circuit 1000 is disposed, and the above-mentioned parasitic-wire-inductor is generated by the trace on the PCB. A lower inductance value (for example, 100 pH) may be selected for the inductive reactance element Lr. In one example, a low inductance value of 100 pH may be achieved when a connecting wire is used as the inductive reactance element Lr.

The switch unit Sa of the spike suppression device 100 may be various types of switch units, such as diodes or transistor switches, including: bipolar junction transistors (BJT), metal oxide semiconducting field effect transistor (MOSFET) or insulated gate bipolar transistor (IGBT), etc.

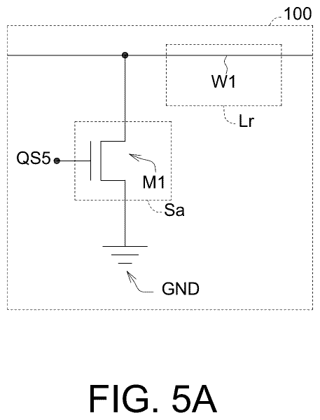

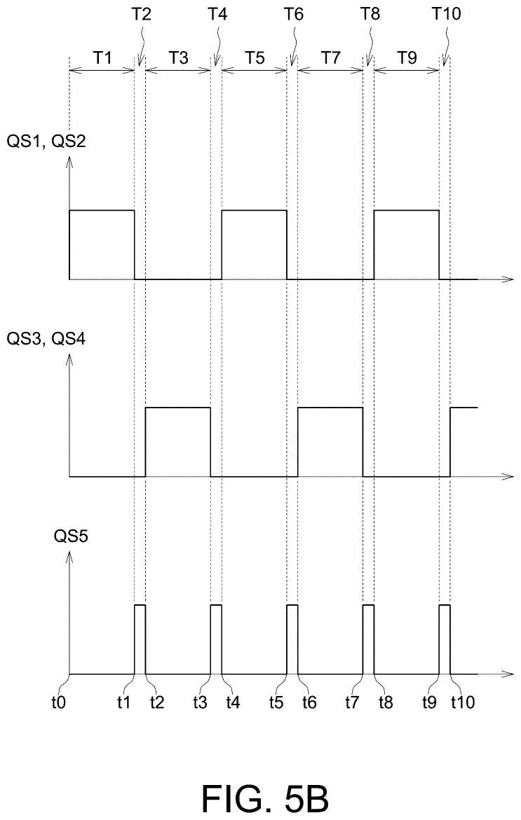

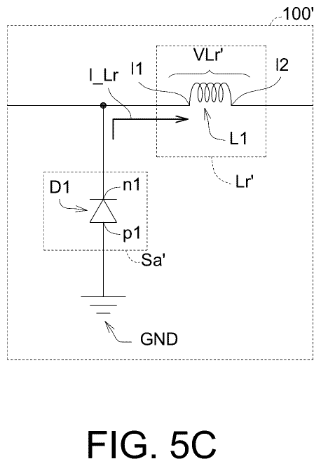

Please refer to FIG. 5A, which illustrates a circuit diagram of a spike suppression device 100 according to an embodiment of the present disclosure. The inductive reactance element Lr in this embodiment is a connecting wire W1, and the switch unit Sa is an N-type metal oxide semiconductor transistor M1 (i.e., the transistor M1 is an NMOS). In operation, the gate of transistor M1 may receive the control signal QS5. On the other hand, the switches S1-S4 of the switched capacitor circuit 1000 receive control signals QS1-QS4 respectively (not shown in FIG. 5A).

Please refer to FIG. 5B, which illustrates waveform diagrams of the control signals QS1-QS5 in the charge mode, the discharge mode and the dead zone. During the periods T1, T5 and T9 the switched capacitor circuit 1000 operates in the charge mode. In the charge mode, the control signal QS5 is at a low level to control the transistor M1 (i.e., the switch unit Sa) to be turned OFF. Moreover, the control signals QS1 and QS2 are both at high level to respectively control the switches S1 and S2 to be turned ON. Furthermore, the control signals QS3 and QS4 are both at low level to respectively control the switches S3 and S4 to be turned OFF.

During the periods T3 and T7, the switched capacitor circuit 1000 operates in the discharge mode. In the discharge mode, the control signal QS5 is at a low level to control the transistor M1 to be turned OFF. Moreover, the control signals QS1 and QS2 are both at low level to respectively control the switches S1 and S2 to be turned OFF. Furthermore, the control signals QS3 and QS4 are both at high level to respectively control the switches S3 and S4 to be turned ON.

During the periods T2, T4, T6, T8 and T10, the switched capacitor circuit 1000 operates in the dead zone. In the dead zone, the control signal QS5 is at a high level to control the transistor M1 to be turned ON. Moreover, the control signals QS1-QS4 are all at low level to respectively control the switches S1-S4 to be turned OFF.

Please refer to FIG. 5C, which illustrates a circuit diagram of a spike suppression device 100′ according to another embodiment of the present disclosure. In this embodiment, the inductive reactance element Lr′ is an inductor L1, and the switch unit Sa′ is a diode D1. One end I1 of the inductor L1 is coupled to the N pole (i.e., cathode) n1 of the diode D1, and the P pole (i.e., anode) p1 of the diode D1 is coupled to the ground end GND.

In operation, in the charge mode and the discharge mode, the induced voltage VLr′ of the inductive reactance element Lr′, which corresponds to the spike current, is: one end I1 of the inductive reactance element Lr′ is a positive voltage, and the other end I2 thereof is a negative voltage. Since the P pole p1 of the diode D1 is coupled to the ground end GND, when the N pole n1 of the diode D1 receives the positive voltage from one end I1 of the inductive reactance element Lr′, the diode D1 is in a reverse biased state, hence diode D1 is turned OFF.

On the other hand, in the dead zone, the induced voltage VLr′ of the inductive reactance element Lr′ is reversed as: one end I1 of the inductive reactance element Lr′ is a negative voltage and the other end I2 thereof is a positive voltage. When the N pole n1 of the diode D1 receives the negative voltage from one end I1 of the inductive reactance element Lr′, the diode D1 is in a forward biased state, hence the diode D1 is turned ON and allows the current I_Lr′ flow through the inductive reactance element Lr′, which is used to release the electrical energy absorbed by the inductive reactance element Lr′.

Moreover, another function of the diode D1 is: when the current (the charge current or the discharge current) in the inductive reactance element Lr′ changes instantaneously, the diode D1 may maintain the potential of the inductive reactance element Lr′ at a lower fixed value, thus limiting the spike current.

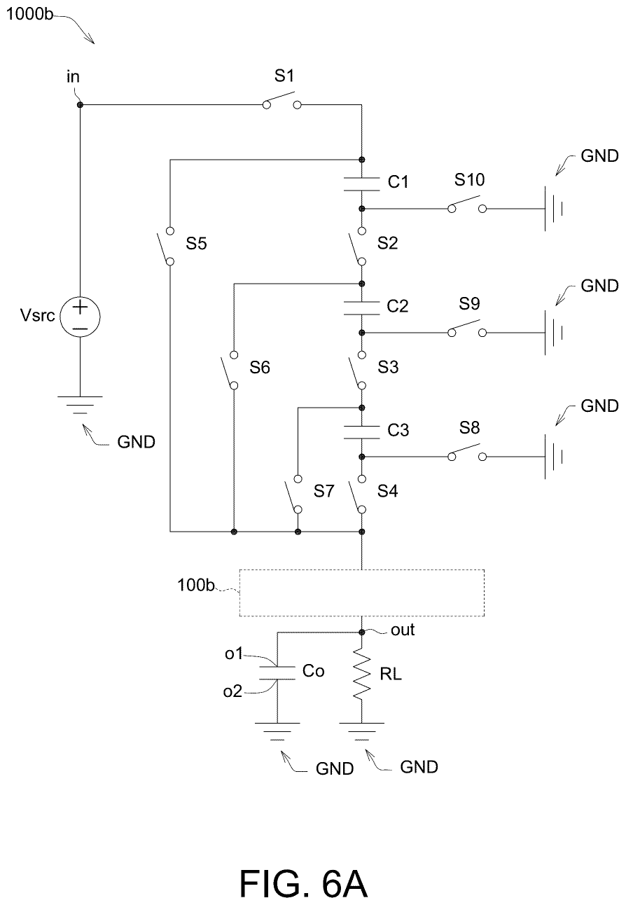

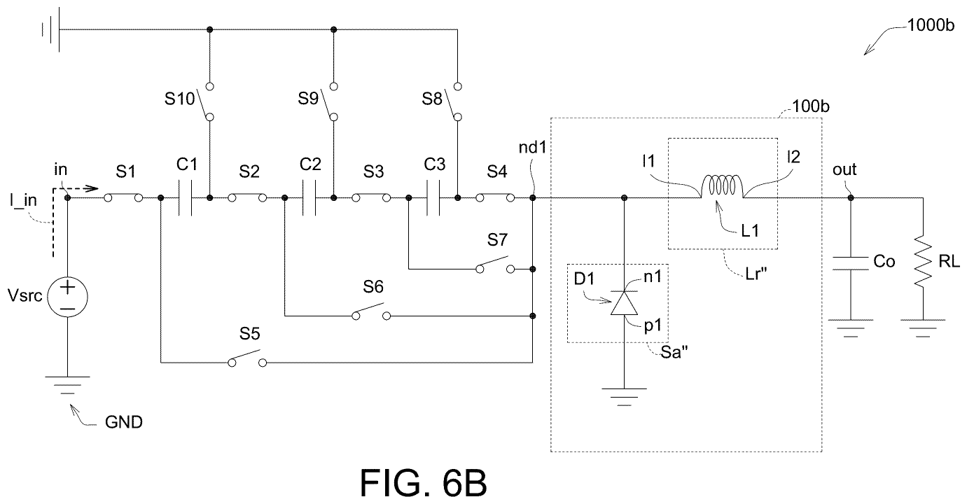

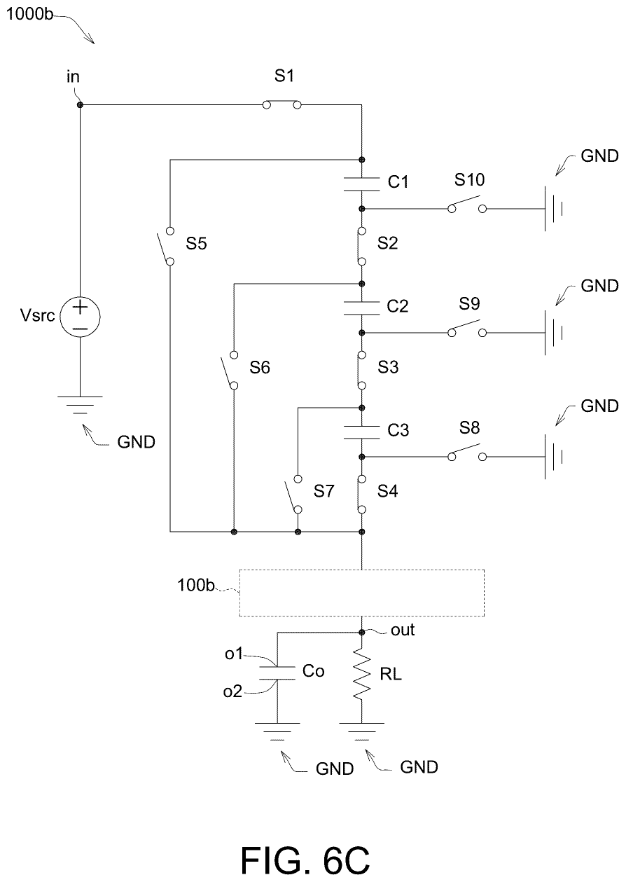

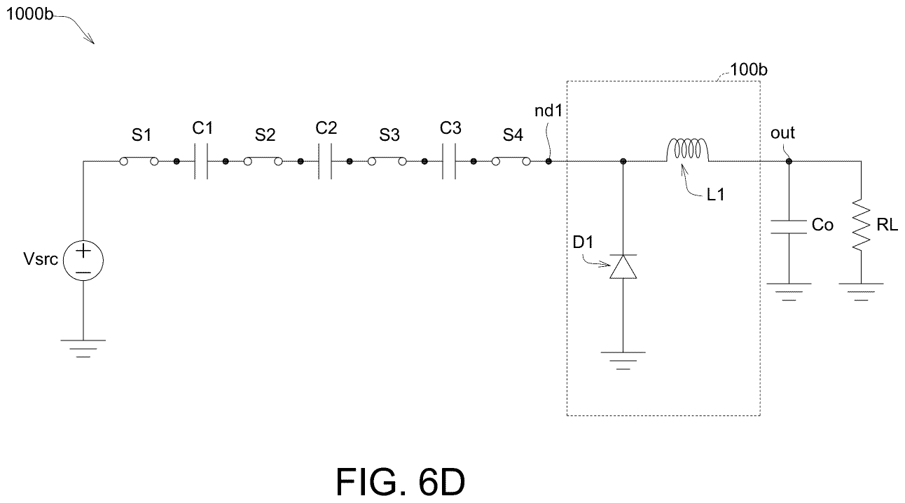

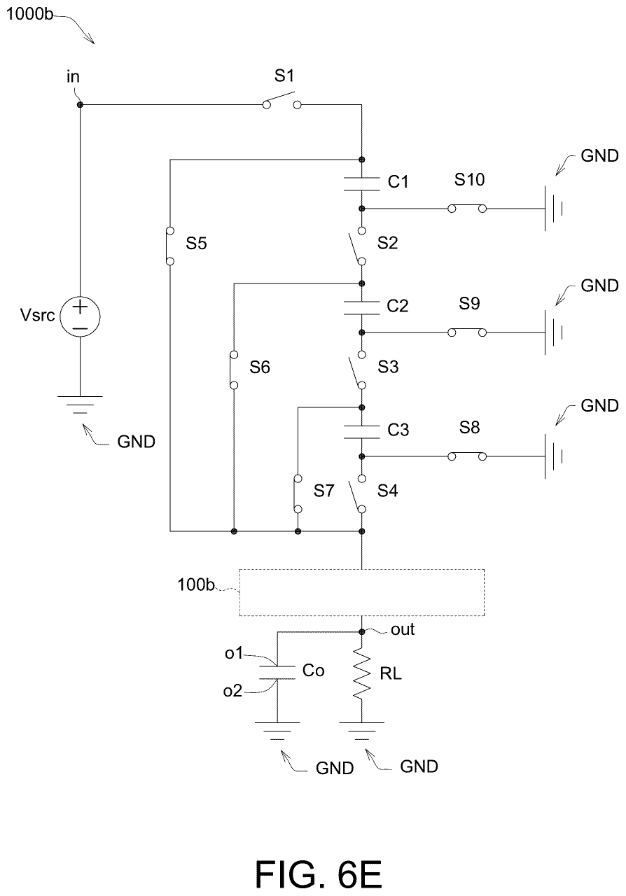

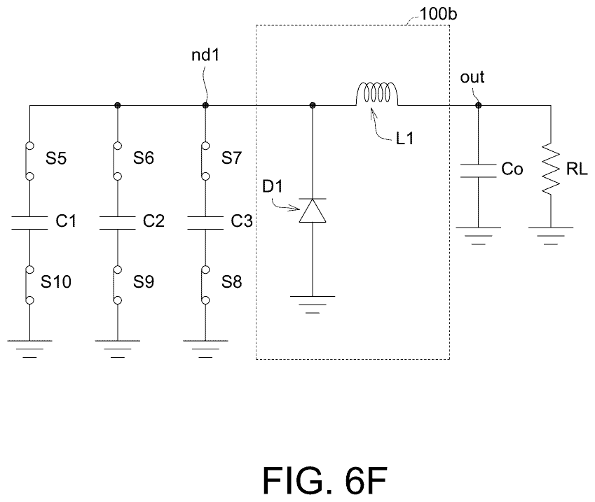

In the embodiments of FIGS. 1, 2A-2C, 3A-3C and 4A-4C, the switched capacitor circuit 1000 includes an input capacitor C1 and four switches S1-S4 (if switch unit Sa of the spike suppression device 100 is not included). Other examples of switched capacitor circuits may include multiple input capacitors and different numbers of switches. Please refer to FIG. 6A, which illustrates a circuit diagram of a switched capacitor circuit 1000b according to another embodiment of the present disclosure. The switched capacitor circuit 1000b includes three input capacitors C1-C3, one output capacitor Co, ten switches S1-S10 and a load impedance RL. The input end “in” of the switched capacitor circuit 1000b is coupled to the voltage source Vsrc, and the output end “out” of the switched capacitor circuit 1000b is coupled to the load resistor RL. The spike suppression device 100b is disposed between the input capacitor C3 and the output capacitor Co. For example, the input capacitor C3 is coupled to the spike suppression device 100b through the switch S4, and the spike suppression device 100b is disposed between the switch S4 and the output capacitor Co.

More specifically, the voltage source Vsrc is coupled between the ground end GND and the input end “in” of the switched capacitor circuit 1000b. The switch S1 is coupled between the input end “in” and the input capacitor C1. The switch S2 is coupled between the input capacitor C1 and the input capacitor C2. The switch S3 is coupled between the input capacitor C2 and the input capacitor C3. The switch S4 is coupled between the input capacitor C3 and the spike suppression device 100b.

One end of the switch S5 is coupled to the switch S1 and the input capacitor C1, and the other end of the switch S5 is coupled to the spike suppression device 100b. One end of the switch S6 is coupled to the switch S2 and the input capacitor C2, and the other end of the switch S6 is coupled to the spike suppression device 100b. One end of the switch S7 is coupled to the switch S3 and the input capacitor C3, and the other end of the switch S7 is coupled to the spike suppression device 100b. One end of the switch S10 is coupled to the switch S2 and the input capacitor C1, and the other end of the switch S10 is coupled to the ground end GND. One end of the switch S9 is coupled to the switch S3 and the input capacitor C2, and the other end of the switch S9 is coupled to the ground end GND. One end of the switch S8 is coupled to the switch S4 and the input capacitor C3, and the other end of the switch S8 is coupled to the ground end GND.

The load resistor RL is coupled between the output end “out” of the switched capacitor circuit 1000b and the ground end GND. One end o1 of the output capacitor Co is coupled to the output end “out” of the switched capacitor circuit 1000b and the load resistor RL. The other end o2 of the output capacitor Co is coupled to the ground end GND.

Please refer to FIG. 6B, which illustrates a circuit diagram of the spike suppression device 100b in FIG. 6A and illustrates its operation and the connection relationship between the elements of the spike suppression device 100b and the switched capacitor circuit 1000b. The switched capacitor circuit 1000b in the embodiment of FIG. 6B is the same as that of the embodiment of FIG. 6A, and the embodiment of FIG. 6B more specifically discloses that the spike suppression device 100b includes an inductive reactance element Lr″ and a switch unit Sa″, where the inductive reactance element Lr″ is the inductor L1, and the switch unit Sa″ is the diode D1. One end I1 of the inductor L1 is coupled to the N pole n1 of the diode D1 and is coupled to the switches S4, S5, S6 and S7. The other end I2 of the inductor L1 is coupled to the output capacitor Co and the load resistor RL. The P pole p1 of the diode D1 is coupled to the ground end GND.

In the embodiment of FIGS. 6A-6F, the switch S4 is disposed between the input capacitor C3 and the inductive reactance element Lr″ (e.g., the inductor L1), hence the switch S4 may be referred to as “the first switch element” of the switched capacitor circuit 1000b (i.e., the role of the switch S4 in this embodiment is similar to the switch S2 in the embodiment of FIG. 1). Moreover, the input capacitor C3 is coupled to the switch S4 (which serves as the role of the “first switch element”), hence the input capacitor C3 may be referred to as the “first input capacitor” of the switched capacitor circuit 1000b of this embodiment. Furthermore, the input capacitor C2 is disposed between the voltage source Vsrc and the input capacitor C3 that plays the role of “first input capacitor”, and the input capacitor C2 is adjacent to the input capacitor C3, therefore, the input capacitor C2 may be referred to as the “the second input capacitor” of this embodiment. In addition, the switch S7 is coupled between the input capacitor C3 and the inductive reactance element Lr″. The load resistor RL is coupled to the inductive reactance element Lr″. In the discharge mode, the switch S7 is turned ON to allow the discharge current of the input capacitor C3 to flow into the load resistor RL through the switch S7 and the inductive reactance element Lr″. Therefore, the switch S7 may be referred to as “the second switch element” of this embodiment. Similarly, switch S6 is coupled between the input capacitor C2 and the inductive reactance element Lr″. In the discharge mode, the switch S6 is turned ON to allow the discharge current of the input capacitor C2 to flow into the load resistor RL; therefore, the switch S6 may be referred to as “the third switch element” of the embodiment.

Please also refer to FIGS. 6C and 6D, which illustrate schematic diagrams of the switched capacitor circuit 1000b of FIG. 6B operating in the charge mode. In the charge mode, switches S1-S4 are all turned ON, and switches S5-S10 are all turned OFF. The input capacitors C1-C3 are coupled to one another other in series through the switches S1-S4 which are turned ON. Furthermore, the input capacitor C3 is coupled to the output capacitor Co and the load resistor RL through the turned-on switch S4 and the spike suppression device 100b. Furthermore, the diode D1 (i.e., the switch unit Sa″) of the spike suppression device 100b is turned OFF (i.e., in a reverse biased state). Accordingly, the coupling manner of the input capacitors C1-C3 and the output capacitor Co is substantially equivalent to series-coupling. The voltage source Vsrc charges the input capacitors C1-C3 and the output capacitor Co (which are equivalently series-coupled) through the turned-on switches S1-S4.

On the other hand, please also refer to FIGS. 6E and 6F, which illustrate schematic diagrams of the switched capacitor circuit 1000b of FIG. 6B operating in the discharge mode. In the discharge mode, switches S1-S4 are all turned OFF, and switches S5-S10 are all turned ON. The input capacitor C1 is coupled to the node nd1 through the turned-on switch S5. Similarly, the input capacitor C2 is coupled to the node nd1 through the turned-on switch S6, and the input capacitor C3 is coupled to the node nd1 through the turned-on switch S7. Furthermore, the output capacitor Co is coupled to the node nd1 through the spike suppression device 100b. Moreover, the diode D1 (i.e., the switch unit Sa″) of the spike suppression device 100b is turned OFF (i.e., in a reverse biased state). Accordingly, the coupling manner of the input capacitors C1-C3 and the output capacitor Co is substantially equivalent to parallel-coupling. The input capacitors C1-C3 and the output capacitor Co (which are equivalently parallel-coupled) perform discharging, and the discharge current flows into the load resistor RL.

In addition, in the intermediate process (i.e., the dead zone) between the charge mode shown in FIGS. 6C and 6D and the discharge mode shown in FIGS. 6E and 6F, all switches S1-S10 are turned OFF (as shown in FIG. 6A). Furthermore, the diode D1 (i.e., the switch unit Sa″) of the spike suppression device 100b is turned ON (i.e., in a forward biased state).

Comprehensive comparison is made between the spike suppression device of the present disclosure in the switched capacitor circuit and the spike suppression mechanisms of several comparative examples. In a comparative example (not shown in the figures), a timing control mechanism is used to control the switching time and switching sequence of the switches, thereby suppressing the spike current. In another comparative example, gate driving technology (e.g., “soft switching” or “slope switching”) is used to control the turning on/off speed of the transistor switches so that the switches may switch smoothly to reduce spike current. In still another comparative example, the ON-resistances of the switches are changed by adjusting the operating points of the switches, thereby suppressing the spike current. Alternatively, a current limiting circuit may be added to control the ON-current of the switches by means of current limiting threshold or current limiting time, thereby suppressing the spike current. However, in each of the above comparative examples, additional control circuits must be disposed to realize the timing control of the switches, or large-volume or high-cost switch units must be added.

Compared with the above comparative examples, for the embodiments of the present disclosure the spike suppression device is disposed between one of the input capacitors (e.g., the input capacitor C1 in the embodiment of FIG. 1 or the input capacitor C3 in the embodiment of FIG. 6A) and the output capacitor Co of the switched capacitor circuit. The inductive reactance element Lr of the spike suppression device may generate an induced voltage VLr in response to the spike current. The induced voltage VLr is opposite to the spike current, hence it may effectively suppress the spike current. Moreover, the path formed by the switch unit Sa of the spike suppression device may release the electrical energy absorbed by the inductive reactance element Lr. The spike suppression device of the present disclosure only includes the inductive reactance element Lr and the switch unit Sa (even, the inductive reactance element Lr may be realized by the existing connecting wire of the switched capacitor circuit, without need to dispose additional inductors), hence having fewer elements. Moreover, the inductive reactance element Lr automatically generates the reverse induced voltage in response to the spike current, without need to apply additional control signal to control the inductive reactance element Lr. Therefore, it may simplify the control mechanism, and may avoid influence by the variation of the process parameters of the inductive reactance element Lr.

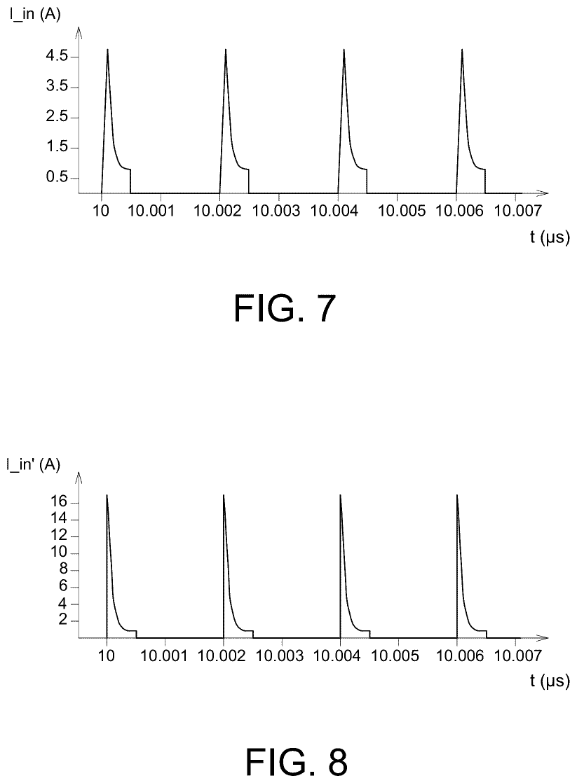

The performance of the spike suppression device of the present disclosure may be seen in FIG. 7, which illustrates a waveform diagram of the input current I_in of the switched capacitor circuit 1000b in FIG. 6B. The inductance value of the inductive reactance element Lr of the spike suppression device is, e.g., 100 pH. FIG. 7 shows that the input current I_in has a spike current with a maximum value of 4.6 A.

In a comparative example, the switched capacitor circuit is not provided with any spike suppression device, and the spike current thereof may be seen in the waveform diagram of the input current I_in′ in FIG. 8. Specifically, FIG. 8 shows that, when lacking of any spike suppression device, the input current I_in′ has a spike current with a maximum value of 16 A, which is much greater than the maximum value of 4.6 A of the spike current of switched capacitor circuit 1000b in the present disclosure. Based on the comparison between the maximum current values of 4.6 A and 16 A, which are respectively measured in the spike currents in the present disclosure and the comparative example, the spike suppression device of the present disclosure may effectively suppress the spike current.

It will be apparent to those skilled in the art that various modifications and variations may be made to the disclosed embodiments. It is intended that the specification and examples be considered as exemplars only, with a true scope of the present disclosure being indicated by the following claims and their equivalents.

What is claimed is:

1. A spike suppression device, for suppressing a spike current in a switched capacitor circuit, wherein the switched capacitor circuit comprises an output capacitor and at least one input capacitor, and the spike suppression device comprising:
an inductive reactance element, disposed between the output capacitor and the at least one input capacitor; and
a switch unit, coupled to the inductive reactance element;
wherein the inductive reactance element is configured to generate an induced voltage in response to the spike current, the induced voltage is opposite to the spike current, and the switch unit is configured to form a discharge path of the inductive reactance element.

2. The spike suppression device according to claim 1, wherein the inductive reactance element is an inductor.

3. The spike suppression device according to claim 1, wherein the inductive reactance element is a wire between the output capacitor and the at least one input capacitor.

4. The spike suppression device according to claim 1, wherein the switch unit is a diode, and a cathode of the diode is coupled to a first end of the inductive reactance element, and a second end of the inductive reactance element is coupled to the output capacitor.

5. The spike suppression device according to claim 1, wherein when the switched capacitor circuit operates in a charge mode, the at least one input capacitor and the output capacitor are equivalently coupled in series and receive a charge current,
wherein when the spike current flows through the inductive reactance element, the induced voltage of the inductive reactance element is opposite to the spike current.

6. The spike suppression device according to claim 1, wherein when the switched capacitor circuit operates in a discharge mode, the at least one input capacitor and the output capacitor are equivalently coupled in parallel and output a discharge current,
wherein when the spike current flows through the inductive reactance element, the induced voltage of the inductive reactance element is opposite to the spike current.

7. The spike suppression device according to claim 1, wherein the switched capacitor circuit further comprises a plurality of switch elements, and a first switch element of the switch elements is disposed between the at least one input capacitor and the inductive reactance element.

8. The spike suppression device according to claim 7, wherein when the switched capacitor circuit operates in a charge mode, the first switch element is turned ON to transmit a charge current, and the charge current flows through the inductive reactance element, and the switch unit of the spike suppression device is turned OFF.

9. The spike suppression device according to claim 8, wherein the switched capacitor circuit is coupled to a voltage source to receive the charge current, and the at least one input capacitor comprising:
a first input capacitor, coupled to the inductive reactance element through the first switch element; and
a second input capacitor, disposed between the voltage source and the first input capacitor;
wherein in the charge mode, at least the first switch element is turned ON to allow the charge current to flow through the first input capacitor, the inductive reactance element and the second input capacitor, and the charge current does not flow through the switch unit of the spike suppression device.

10. The spike suppression device according to claim 7, wherein when the switched capacitor circuit operates in a discharge mode, the first switch element is turned OFF, and the switch unit of the spike suppression device is turned OFF.

11. The spike suppression device according to claim 10, further comprising a load resistor coupled to the inductive reactance element, wherein the switch elements further comprise a second switch element and a third switch element, and the at least one input capacitor comprising:
a first input capacitor, coupled to the first switch element, and coupled to the inductive reactance element through the second switch element; and
a second input capacitor, adjacent to the first input capacitor, and coupled to the inductive reactance element through the third switch element;
wherein in the discharge mode, the first input capacitor and the second input capacitor provide a discharge current, and at least the second switch element and the third switch element are turned ON to allow the discharge current to flow into the load resistor through the inductive reactance element, and the discharge current does not flow through the switch unit of the spike suppression device.

12. The spike suppression device according to claim 7, wherein when the switched capacitor circuit operates in a dead zone, the switch elements are all turned OFF, and the switch unit of the spike suppression device is turned ON to form the discharge path of the inductive reactance element.

13. The spike suppression device according to claim 12, wherein the switch unit is a diode, and a cathode of the diode is coupled to the first switch element and the inductive reactance element, when the switched capacitor circuit operates in the dead zone, the cathode of the diode has a negative voltage to turn the diode ON.
